(19) United States
(12) Patent Application Publication
(10) Pub. No.: US 2026/0208784 A1
(43) Pub. Date: Jul. 23, 2026

(54) SYSTEM AND METHOD FOR IDENTIFYING DEGRADATION IN A STEER-BY-WIRE SYSTEM

(71) Applicant: GM GLOBAL TECHNOLOGY OPERATIONS LLC, Detroit, MI (US)

(72) Inventors: Mahdokht Ezati, Pickering (CA); Seyedeh Asal Nahidi, North York (CA); Amin Habibnejad Korayem, Markham (CA)

(73) Assignee: GM GLOBAL TECHNOLOGY OPERATIONS LLC, Detroit, MI (US)

(21) Appl. No.: 19/032,879

(22) Filed: Jan. 21, 2025

(51) Int. Cl. B62D 5/00; B62D 5/04

(52) U.S. Cl. CPC B62D 5/006; B62D 5/0409; B62D 5/046

(57) ABSTRACT

A steer-by-wire system includes a hand wheel actuator coupled to a steering column, a road wheel actuator configured to drive a steering rack with a pinion gear, and a controller in electrical communication with the hand wheel actuator and the road wheel actuator. The controller is configured to determine an actual Ĉ_{factor} for the steer-by-wire system and determine a C-factor difference between the actual Ĉ_{factor} and the nominal C_{factor} when the actual Ĉ_{factor} is less than the nominal C_{factor}. The steer-by-wire system includes a nominal C_{factor} defining a ratio of travel of the steering rack per revolution of the pinion gear. The controller is also configured to determine a degradation status for the steer-by-wire system based on the C-factor difference and provide a response based on the degradation status.

### BACKGROUND

The present disclosure relates to steering a vehicle, and more particularly, to a steering system that dynamically adjusts steering in a steer-by-wire system.

Steer-by-wire systems are an alternative to mechanical steering linkages that provide a direct mechanical connection found on many vehicles. Steer-by-wire systems utilize electronic controls and actuators to translate input into the hand wheel by a driver into an output that will result in the steerable road wheels moving to a desired road angle. Mechanical steering systems rely on a direct mechanical connection between the hand wheel and the steerable wheels through a steering column, rack and pinion, or similar mechanisms. Mechanical steering systems may include a motor or hydraulic power assist to aid the driver in turning the steerable wheels.

### SUMMARY

Disclosed herein is a steer-by-wire system. The steer by wire system includes a hand wheel actuator coupled to a steering column, a road wheel actuator configured to drive a steering rack with a pinion gear, and a controller in electrical communication with the hand wheel actuator and the road wheel actuator. The controller is configured to determine an actual Ĉ_{factor} for the steer-by-wire system and determine a C-factor difference between the actual Ĉ_{factor} and the nominal C_{factor} when the actual Ĉ_{factor} is less than the nominal C_{factor}. The steer-by-wire system includes a nominal C_{factor} defining a ratio of travel of the steering rack per revolution of the pinion gear. The controller is also configured to determine a degradation status for the steer-by-wire system based on the C-factor difference and provide a response based on the degradation status.

In one aspect of the disclosure the controller is configured to determine the degradation status by comparing an absolute value of the C-factor difference to a predetermined range of values.

In one aspect of the disclosure the response provided by the controller includes applying a compensation C-factor to the steer-by-wire system when the C-factor difference is within a first predetermined range of values.

In one aspect of the disclosure the response provided by the controller includes an alert when the C-factor difference is within a second predetermined range of values.

In one aspect of the disclosure the alert includes a service notification.

In one aspect of the disclosure the response provided by the controller includes an alert when the C-factor difference is within a third predetermined range of values.

In one aspect of the disclosure the alert includes at least one of a service notification or a drivability notification.

In one aspect of the disclosure the actual Ĉ_{factor} is determined based on an estimated steering rack displacement and a measured pinion angle.

In one aspect of the disclosure the estimated rack displacement is determined based on parameters regarding the road wheel actuator.

In one aspect of the disclosure the parameters regarding the electrical motor include a motor current, a motor voltage, a motor inductance, a motor resistance, and a back electromotive force and the parameters regarding the road wheel actuator include, a mass, a stiffness, a damping, and a steering arm length.

In one aspect of the disclosure the controller is configured to utilize an observer to determine the estimated rack displacement based on estimated rack force and the motor voltage as control inputs and road wheel actuator motor torque as a measurable control output.

In one aspect of the disclosure the controller is configured to determine pinion angle displacement and determine the actual Ĉ_{factor} based on the estimated steering rack displacement and the pinion angle displacement.

Disclosed herein is a vehicle having a steer-by-wire system. The vehicle includes a body at least partially defining a passenger cabin, at least one steerable wheel supporting the body, a hand wheel actuator coupled to a steering column, a road wheel actuator configured to drive a steering rack with a pinion gear and a controller in electrical communication with the hand wheel actuator and the road wheel actuator and configured to apply a nominal C_{factor}. The controller is configured to determine an actual Ĉ_{factor} for the steer-by-wire system and determine a C-factor difference between the actual Ĉ_{factor} and the nominal C_{factor} when the actual Ĉ_{factor} is less than the nominal C_{factor}. The steer-by-wire system includes a nominal C_{factor} defining a ratio of travel of the steering rack per revolution of the pinion gear. The controller is also configured to determine a degradation status for the steer-by-wire system based on the C-factor difference and provide a response based on the degradation status.

Disclosed herein is a method of operating a steer-by-wire system. The method includes determining an actual Ĉ_{factor} for the steer-by-wire system and determining a C-factor difference between actual Ĉ_{factor} and a nominal C_{factor} when the actual Ĉ_{factor} is less than the nominal C_{factor}. The nominal C_{factor} defines a ratio of travel of a steering rack per revolution of a pinion gear. The method also includes determining a degradation status for the steer-by-wire system based on the C-factor difference and providing a response based on the degradation status.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 schematically illustrates a vehicle including an example steer-by-wire system.

FIG. 2 is a flow diagram of a method of operating the steer-by-wire system of FIG. 1.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

During operation of vehicles with a mechanical steering system, the steering rack, tie rod ends, bushings, and other components can degrade over time. Because the steering ratio between input from the steering wheel and road angle is fixed with mechanical systems, the road angle produced for a given input to the steering wheel will be reduced. Because steer-by-wire systems do not include a steering ratio fixed by mechanical components, a steer-by-wire system according to this disclosure can compensate for wear that may reduce road wheel angle.

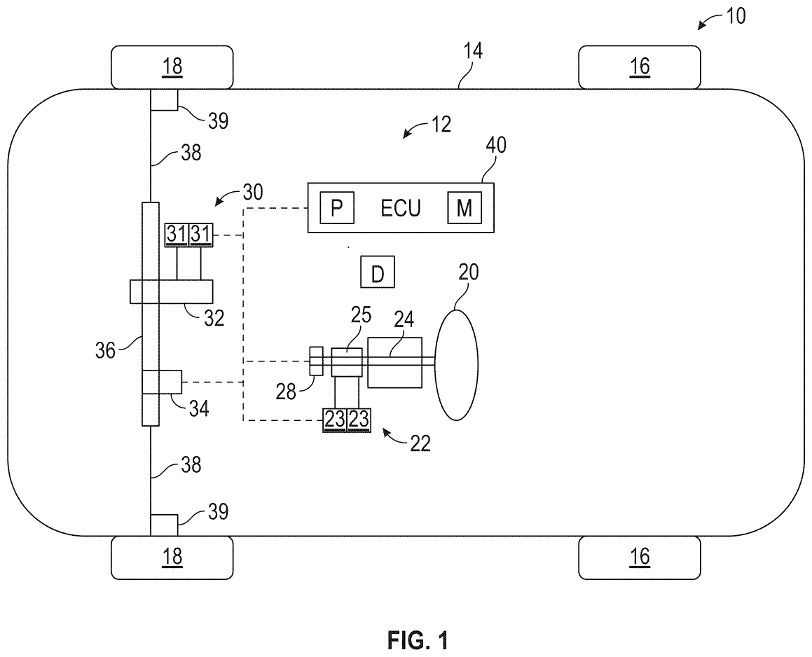

FIG. 1 illustrates an example of a vehicle 10 including a steering system 12, such as a steer-by-wire system. In the illustrated example, the vehicle 10 includes a body 14 at least partially defining a passenger cabin that is supported by a pair of rear wheels 16 and a pair of front wheels 18 that are steerable to create a road angle for steering the vehicle 10 in a desired direction. The steering system 12 includes a hand wheel actuator (HWA) 22 mechanically connected to a hand wheel 20, such as a steering wheel, and a road wheel actuator (RWA) 30 mechanically connected to a steering rack 36 for moving the front wheels 18 to different road angles.

The hand wheel 20 is connected to an upper steering column 24 such that rotation of the hand wheel 20 in a desired direction causes the upper steering column to rotate in the same rotational direction and speed. A steering angle sensor (SAS) 28 is attached to the steering column 24 and monitors steering input from the hand wheel 20. In particular, the SAS 28 determines a position and rate of rotation of the hand wheel 20. The position and rate of rotation of the hand wheel 20 determined by SAS 28 is communicated to an electronic control unit (ECU) 40 or controller as will be discussed in greater detail below.

In the illustrated example, the HWA 22 includes redundant drive units 23 each have a motor and motor controller each in communication with a gear drive 25 mechanically connected to the upper steering column 24. When the ECU 40 receives position and rate of rotation information from the SAS 28, the ECU 40 provides a feedback torque command for the HWA 22 that is received by at least one of the motor controllers. The feedback torque command directs the HWA 22 to apply a feedback torque to the steering column 24 that is felt by the driver engaging the hand wheel 20. One feature of the HWA 22 is to provide the driver with feedback from the front wheels 18 similar to a mechanical steering system.

The steering system 12 also includes a road wheel actuator (RWA) 30 in electrical communication with the ECU 40. The RWA 30 is engaged with a steering rack 36 through a gear drive 32 that directs the front wheels 18 to have different road angles. In the illustrated example, the RWA 30 includes redundant drive units 31 each having a motor and a motor controller. Each of the motor and controller combinations are configured to receive command signals from the ECU 40 to drive the gear drive 32 and cause the steering rack 36 to move the front wheels 18 to the desired road angle. In a steer-by-wire system 12, the ECU 40 applies a C_{factor} to the input received from the HWA 22. In one example, the C_{factor} refers to a ratio between steering wheel angle input and displacement of the steering rack 36. In a traditional mechanical steering system, a relationship between the driver input (steering wheel angle) and the vehicle response through steering rack 36 displacement (steering road angle) is fixed by mechanical linkages. However, because the steer-by-wire system 12 does not include a direct mechanical connection between the hand wheel 20 and the road wheels 18, the C_{factor} applied by the ECU 40 can be dynamically adjusted. As discussed in greater detail below, one feature of this disclosure is to address degradation relating to steering the vehicle 10 by determining a compensating or virtual C_{factor} that maintains the same steering response for the vehicle 10 when components begin to degrade.

As shown in FIG. 1, the steering rack 36 is connected to a steering knuckle 39 at each of the front wheels 18 through a pair of tie rods 38. The front wheels 18 are rotatably connected to the knuckle 39 through a wheel bearing hub. Lateral movement of the tie rods 38 causes the front wheels 18 to have a desired road angle. A lateral position of the steering rack 36 is monitored through a rack position sensor 34 that is in electric communication with the ECU 40 to provide information to the ECU 40 regarding the position and movement, such as acceleration and velocity, of the steering rack 36. Accordingly, the ECU 40 provides suitable signals to the RWA 30 to change position of the steering rack 36 and the rack position sensor 34 monitors the position of the steering rack 36 and communicates that information to the ECU 40 for control purposes.

In this disclosure, the ECU 40 may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock. The ECU 40 also includes an associated non-transitory computer-readable storage medium, i.e., memory (M) inclusive of read only, programmable read only, random access, a hard drive, etc., whether resident, remote or a combination of both.

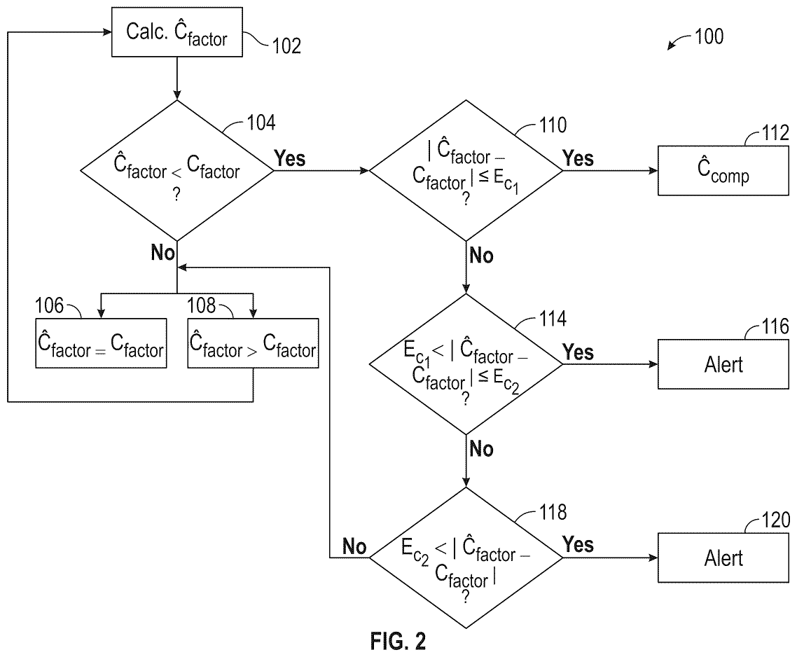

FIG. 2 illustrates an example method 100 of operating the steer-by wire system 12 of FIG. 1. The method 100 beings at block 102 (“Calc. Ĉ_{factor}”), by calculating an actual Ĉ_{factor} for the steer-by-wire system 12 at a given point in time. The Ĉ_{factor} can capture degradation in steering related components beyond the steering rack 36, such as bushings, tie-rod ends, damaged components, etc. Accordingly, one feature of calculating Ĉ_{factor} is that it provides additional information beyond simply measuring displacement of the steering rack 36.

The method 100 utilizes a mathematical model to calculate Ĉ_{factor}. The mathematical model provided an estimated rack displacement based on an estimated rack force by utilizing EQS. 1-2 below.

$${T}_{m} = {m}_{R} {\ddot{X}}_{R} + {C}_{R} {\dot{X}}_{R} + {B}_{R} {X}_{R} + {F}_{F} sgn ( {\dot{X}}_{R} ) + {k}_{R} {F}_{R} \qquad EQ . 1$$

$${V}_{m} = {L}_{m} {\dot{I}}_{m} + {R}_{m} {I}_{m} + {K}_{emf} {\dot{X}}_{R} \qquad EQ . 2$$

In EQ. 1, Tₘ refers to road wheel angle motor torque, X_{R} refers to rack position, \dot{X}_{R} refers to rack velocity, \ddot{X}_{R} refers to rack velocity, B_{R} refers to electric motor stiffness, such as for the drive units 31, C_{R} refers to electric motor damping, m_{R} equivalent rack weight, F_{F} refers to frictional force, k_{R} refers to steering arm length, and F_{R} refers to rack force. Furthermore, in EQ. 1, B_{R}, C_{R}, F_{F}, and m_{R} are system specific parameters that can be measured or determined separately from operating the steer-by-wire system 12. In EQ. 2, Iₘ, Vₘ, Lₘ, Rₘ, and K_{emf}, refer to electric motor current, voltage, inductance, resistance, and motor back EMF, respectively.

With EQS 1-2, a state-space model is developed to design a Kalman Filter observer to estimate rack position displacement based on rack force and electric motor voltage inputs utilizing EQS. 3-7 below.

$${\dot{X}}_{RWA} = {A}_{RWA} {X}_{RWA} + {B}_{RWA} {u}_{RWA} \qquad EQ . 3$$

$${Y}_{RWA} = {C}_{RWA} {X}_{RWA} \qquad EQ . 4$$

With EQS. 3-4, A_{RWA} and B_{RWA} represents a state matrix and an input matrix, respectively, that are extracted from EQS 1-2, X_{RWA} is presented by EQ. 5 below, u_{RWA} is represented by EQ. 6 below, and Y_{RWA} is represented with EQ. 7.

$${X}_{RWA} = \{ \begin{matrix}{X}_{R} \\ {\dot{X}}_{R} \\ {I}_{m}\end{matrix} \} \qquad EQ . 5$$

$${u}_{RWA} = \{ \begin{matrix}{V}_{m} \\ {F}_{R}\end{matrix} \} \qquad EQ . 6$$

$${Y}_{RWA} = {T}_{m} \qquad EQ . 7$$

A Kalman Filter observer is designed and calibrated utilizing the above EQS. to estimate rack position displacement based on rack force and electric motor voltage inputs. The estimated rack position displacement and measurement of a pinion angle displacement from a motor position sensor in the drive units 31 are utilized to compute the actual Ĉ_{factor} with EQ. 8 below. In one example, the measure pinion angle is determined based on one of the drive units 31.

$${\hat{C}}_{factor} = \frac{{\hat{X}}_{R}}{{θ}_{P}} \qquad EQ . 8$$

In EQ. 8 above, \hat{X}_{R} is the estimated rack displacement at a given time and θ_{P} is the measurement of pinion angle displacement. With the actual Ĉ_{factor} calculated as explained above, the method 100 then proceeds to block 104.

At block 104 (“Ĉ_{factor}<C_{factor}?”), the method 100 compares the actual Ĉ_{factor} to the nominal C_{factor} applied by the ECU 40. When the actual Ĉ_{factor} is not less than the nominal C_{factor}, the method 100 proceeds to blocks 106 and 108. At block 106 (“Ĉ_{factor}=C_{factor}”), the method 100 determines if the actual Ĉ_{factor} is equal to the nominal C_{factor}. When they are equal, the steer-by-wire system 12 has not degraded and indicates that the actual performance of the steer-by-wire system 12 matches a predicted or expected performance for the steer-by-wire system 12. Accordingly, when the actual Ĉ_{factor} is equal to the nominal C_{factor}, the method 100 does not take additional actions and the method 100 ends.

When the method 100 proceeds to block 108 (“Ĉ_{factor}>C_{factor}”), the method 100 determines if the actual Ĉ_{factor} is greater than the nominal C_{factor}. When this is true, the results from block 104 are invalid as the actual Ĉ_{factor} would not be greater than the nominal C_{factor}. In this scenario, the method 100 ends or return to block 102 to recalculate the actual Ĉ_{factor}.

When the actual Ĉ_{factor} is less than the nominal C_{factor} at block 104, the method 100 proceeds to block 110. When this relationship is true, there is degradation in the steering related components of the vehicle 10 and the method 100 will evaluate a degree of the degradation. At block 110 (“|Ĉ_{factor}−C_{factor}|≤E_{c1}?”), the method 100 compares an absolute value of a difference between the actual Ĉ_{factor} and the nominal C_{factor} to a predetermined threshold value or range of values. For example, if |Ĉ_{factor}−C_{factor}| is less than or equal to E_{c1} and greater than zero, the method 100 proceeds to block 112.

At block 112 (“Ĉ_{comp}”), the method 100 determines a new C_{factor} for the ECU 40 to apply to remedy the degradation in the steering related components of the vehicle 10. In the illustrated example, the new C_{factor} compensates for the degradation is referred to as Ĉ_{comp}. In one example, the method 100 calculates Ĉ_{comp} using EQ. 9 below.

$${\hat{C}}_{comp} = \frac{{C}_{factor}}{{\hat{C}}_{factor}} \qquad EQ . 9$$

One feature of Ĉ_{comp} is that it creates a steering rack displacement under actual conditions that matches a predicted steering rack displacement utilizing the nominal C_{factor} for a system without degradation. Furthermore, when |Ĉ_{factor}−C_{factor}| is greater than E_{c1}, the method 100 proceeds to block 114.

At block 114 (“E_{c1}<|Ĉ_{factor}−C_{factor}|≤E_{c2}?”), the method 100 compares an absolute value of a difference between the actual Ĉ_{factor} and the nominal C_{factor} to a range of threshold values greater than E_{c1} and less than or equal to a second threshold value E_{c2}. When |Ĉ_{factor}−C_{factor}| falls within this range, the method 100 proceeds to block 116.

At block 116 (“Alert”), the method 100 issues an alert to a user of the vehicle 10. In one example, the alert is presented on a display D within the vehicle 10. In one example, the alert includes a service notification regarding steering related components on the vehicle 10. When the actual Ĉ_{factor} is within the range shown in block 114, the method 100 does not attempt to correct for the degradation of the steering related components by having the ECU 40 apply Ĉ_{comp}. Furthermore, when |Ĉ_{factor}−C_{factor}| is greater than E_{c2}, the method 100 proceeds to block 118.

At block 118 (“E_{c2}<|Ĉ_{factor}−C_{factor}|?”), the method 100 compares an absolute value of a difference between the actual C_{factor} and the nominal C_{factor} to a range of threshold values greater than E_{c2}. When |Ĉ_{factor}−C_{factor}| does not fall within the range of block 118, the method 100 proceeds to blocks 106 and 108 for further evaluation as described above. When |Ĉ_{factor}−C_{factor}| falls within the range shown in block 118, the method 100 proceeds to block 120.

At block 120 (“Alert”), the method 100 issues an alert to a user of the vehicle 10. In one example, the alert is presented on a display D within the vehicle 10. In one example, the alert includes a service notification or a drivability notification regarding steering related components on the vehicle 10. When the actual Ĉ_{factor} is within the range shown in block 118, the method 100 does not attempt to correct for the degradation of the steering related components by having the ECU 40 apply Ĉ_{comp}.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A steer-by-wire system comprising:
a hand wheel actuator coupled to a steering column;
a road wheel actuator configured to drive a steering rack with a pinion gear; and
a controller in electrical communication with the hand wheel actuator and the road wheel actuator, wherein the controller is configured to:
determine an actual Ĉ_{factor} for the steer-by-wire system;
determine a C-factor difference between the actual Ĉ_{factor} and the nominal C_{factor} when the actual Ĉ_{factor} is less than the nominal C_{factor}, wherein the steer-by-wire system includes a nominal C_{factor} defining a ratio of travel of the steering rack per revolution of the pinion gear;
determine a degradation status for the steer-by-wire system based on the C-factor difference; and
provide a response based on the degradation status.

2. The system of claim 1, wherein the controller is configured to determine the degradation status by comparing an absolute value of the C-factor difference to a predetermined range of values.

3. The system of claim 1, wherein the response provided by the controller includes applying a compensation C-factor to the steer-by-wire system when the C-factor difference is within a first predetermined range of values.

4. The system of claim 1, wherein the response provided by the controller includes an alert when the C-factor difference is within a second predetermined range of values.

5. The system of claim 4, wherein the alert includes a service notification.

6. The system of claim 1, wherein the response provided by the controller includes an alert when the C-factor difference is within a third predetermined range of values.

7. The system of claim 6, wherein the alert includes at least one of a service notification or a drivability notification.

8. The system of claim 1, wherein the actual Ĉ_{factor} is determined based on an estimated steering rack displacement and a pinion angle displacement.

9. The system of claim 8, wherein the estimated steering rack displacement is determined based on parameters regarding the road wheel actuator.

10. The system of claim 9, wherein the parameters regarding an electrical motor in the road wheel actuator include a motor current, a motor voltage, a motor inductance, a motor resistance, and a back electromotive force and the parameters regarding the road wheel actuator include, a mass, a stiffness, a damping, and a steering arm length.

11. The system of claim 10, wherein the controller is configured to utilize an observer to determine the estimated steering rack displacement based on estimated rack force and the motor voltage as control inputs and road wheel actuator motor torque as a measurable control output.

12. The system of claim 8, wherein the controller is configured to determine a pinion angle displacement and determine the actual Ĉ_{factor} based on the estimated steering rack displacement and the pinion angle displacement.

13. A vehicle having a steer-by-wire system, comprising:
a body at least partially defining a passenger cabin;
at least one steerable wheel supporting the body;
a hand wheel actuator coupled to a steering column;
a road wheel actuator configured to drive a steering rack with a pinion gear; and
a controller in electrical communication with the hand wheel actuator and the road wheel actuator and configured to apply a nominal C_{factor}, wherein the controller is configured to:
determine an actual Ĉ_{factor} for the steer-by-wire system;
determine a C-factor difference between the actual Ĉ_{factor} and the nominal C_{factor} when the actual Ĉ_{factor} is less than the nominal C_{factor}, wherein the steer-by-wire system includes a nominal C_{factor} defining a ratio of travel of the steering rack per revolution of the pinion gear;
determine a degradation status for the steer-by-wire system based on the C-factor difference; and
provide a response based on the degradation status.

14. The vehicle of claim 13, wherein the controller is configured to determine the degradation status by comparing an absolute value of the C-factor difference to a predetermined range of values.

15. The vehicle of claim 13, wherein the response provided by the controller includes applying a compensation C-factor to the steer-by-wire system when the C-factor difference is within a first predetermined range of values.

16. The vehicle of claim 13, wherein the response provided by the controller includes an alert when the C-factor difference is within a second predetermined range of values.

17. The vehicle of claim 16, wherein the alert includes a service notification.

18. The vehicle of claim 13, wherein the response provided by the controller includes an alert when the C-factor difference is within a third predetermined range of values and the alert include at least one of a service notification or a drivability notification.

19. A method of operating a steer-by-wire system, the method comprising:
determining an actual Ĉ_{factor} for the steer-by-wire system;
determining a C-factor difference between actual Ĉ_{factor} and a nominal C_{factor} when the actual Ĉ_{factor} is less than the nominal C_{factor}, wherein the nominal C_{factor} defines a ratio of travel of a steering rack per revolution of a pinion gear;
determining a degradation status for the steer-by-wire system based on the C-factor difference; and
providing a response based on the degradation status.

20. The method of claim 19, wherein the response includes applying a compensation C-factor to the steer-by-wire system when the C-factor difference is within a first predetermined range of values and the response includes an alert when the C-factor difference is within a second predetermined range of values.
